(19) United States
(12) Patent Application Publication
(10) Pub. No.: US 2014/0106048 A1
(43) Pub. Date: Apr. 17, 2014

(54) BEVERAGE DISPENSER

(71) Applicant: Michel Harper, Surrey (GB)

(72) Inventor: Michel Harper, Surrey (GB)

(73) Assignee: SHELL SHOTS LIMITED, Surrey (GB)

(21) Appl. No.: 14/114,271

(22) PCT Filed: Mar. 14, 2012
(86) PCT No.: PCT/GB12/50561

§ 371 Date: Oct. 28, 2013

(30) Foreign Application Priority Data
Mar. 14, 2011 (GB) 1104271.0

(51) Int. Cl. C12G 3/06; B65B 3/04

(52) U.S. Cl. CPC C12G 3/06; B65B 3/04
USPC 426/548; 426/573; 426/577; 426/578; 426/575; 426/576; 53/467

(57) ABSTRACT

The present invention relates to a beverage dispenser for dispensing a gelatinous beverage. The present invention also relates to a gelatinous beverage for use in a beverage dispenser, and more specifically an alcoholic gelatinous beverage. The beverage dispenser comprises a housing and a gelatinous beverage contained within the housing, the housing being configured for movement between a closed configuration in which the gelatinous beverage is sealed within the housing and an open configuration in which the gelatinous beverage may be dispensed from the housing. The gelatinous beverage may comprise at least one alcoholic ingredient, at least one gelling agent, at least one acidity regulator, at least one preservative and at least one dilutant.

The present invention relates to a beverage dispenser for dispensing a gelatinous beverage. The present invention also relates to a gelatinous beverage for use in a beverage dispenser, and more specifically an alcoholic gelatinous beverage.

Beverage dispensers typically take the form of glasses, cups or mugs. Such dispensers can be made in any shape or size based on the beverage intended to be contained therein. For example, a glass for containing a beverage having a high alcoholic content, such as spirits, may be smaller than those intended for containing a beverage having a low alcoholic content, for example beer.

However, the known beverage dispensers are not suitable for storing and dispensing gel-based beverages having a desirable consistency and mouth-feel. Due to the texture and composition of gel-based beverages, known beverage dispensers are not suitable both to store and dispense such beverages.

Jelly is made by dissolving a gelling agent, typically gelatin, in hot liquid, typically water or fruit juice, with the desired flavors and other additives. The desired flavours and additives can comprise sugar or a sugar substitute and/or a fruit flavourings. The additional flavours and additives may be added and varied during preparation of the jelly, or pre-mixed with the gelling agent in a commercial product.

A gel-based shot is a novelty jelly wherein an alcohol, usually vodka, replaces some of the water or fruit juice that is used to congeal the gel.

However, existing gel-based shots do not have a desirable consistency and mouth-feel and are not available for long-term storage, thus making them unsuitable for commercial uses. It is therefore desirable to provide a gel beverage having a desirable consistency and mouth-feel.

Furthermore, there are no beverage dispensers currently suitable for storing and dispensing a gel-based shot.

Therefore, it is an object of the present invention to provide a beverage dispenser for storing and dispensing a gelatinous beverage which overcomes the disadvantages of the aforementioned dispensers and provides a fun and pleasurable means of consuming a beverage.

Thus, according to a first aspect of the present invention, there is provided a beverage dispenser comprising a housing and a gelatinous beverage contained within the housing, the housing being configured for movement between a closed configuration in which the gelatinous beverage is sealed within the housing and an open configuration in which the gelatinous beverage may be dispensed from the housing.

The beverage dispenser of the present invention provides an easy to use and enjoyable means of dispensing a gelatinous beverage to a user. Further, when sealed in the closed configuration, the beverage dispenser is suitable for packaging and transport with the gelatinous beverage contained therein. Beneficially, this ensures that the gelatinous beverage contained therein has a longer shelf-life and allows for easy packaging and transport to the intended retail outlets. Further, the beverage dispenser of the present invention can be sold directly to the consumer with no prior preparation step. This is of particular benefit to consumers wishing to consume a gelatinous beverage without wishing to wait for its preparation.

The housing may be made of any suitable flexible or rigid material. For example, the housing may be made from wood, plastics or paper material. Preferably, the housing is recyclable.

Preferably, the housing is made from a food grade plastics material and more preferably from a rigid food grade plastics material. Suitable plastics materials will be well known to a person skilled in the art, but may include high density polyethylene. The plastics housing may be prepared by any suitable moulding process known to a person skilled in the art. Such moulding processes may include, for example, injection moulding and blow moulding.

The housing may be of any size suitable for containing a gelatinous beverage therein. Preferably, the housing is airtight when sealed in the closed configuration. Beneficially, this prevents outside contamination of the gelatinous beverage contained in the housing and prolongs its shelf-life. Further, this is also of benefit in transporting the beverage dispenser as there is no leakage of the gelatinous beverage from the housing.

The housing can be moved from a closed configuration, in which the housing defines a central cavity for sealing a pre-determined volume of gelatinous beverage therein, to an open configuration, in which the gelatinous beverage contained therein may be dispensed to the user.

The housing may comprise first and second sections.

The first and second sections may be substantially hemi-spherical.

Preferably, the housing comprises the shape of a shell, for example an oyster shell, such that the first and second sections may correspond to the shape of the two half-shells of the oyster shell. In such an embodiment, the housing may comprise a plastics material moulded to resemble a shell, such as an oyster shell. In an alternative embodiment, there is provided an oyster shell for use as a beverage dispenser.

The first and second sections may be moveable relative to each other. In some embodiments, the first and second sections may be pivotally connected to move between a closed configuration and an open configuration.

Additionally or alternatively, the first and second sections may be sealed together by a breakable connection, such that opening the housing from its closed position results in the first and second sections separating. The first and second sections may be sealed by an adhesive or by a peg and hole connection. The adhesive may be any suitable food grade adhesive known in the art.

Additionally or alternatively, the housing may comprise a fastening means for re-sealing the shell in the closed configuration once it has been in the open configuration. Suitable fastening means would be apparent to a person skilled in the art but may comprise, for example, a clip fastener, a re-sealable adhesive, peg and hole fastener or the like. Alternatively, the housing may comprise no fastening means such that the re-fastening of the housing from an open configuration into a closed configuration is not possible.

In some embodiments, the movement of the housing from a closed configuration to an open configuration renders the housing incapable of returning to the initial closed configuration. In such embodiments, the opening of the housing results in the irreparable breaking of the seal holding the housing in the closed configuration. This may result from a separation of the first and second sections.

In some embodiments, the first section may comprise a lid and the second section is suitable for receiving a gelatinous beverage as described herein.

The lid may be adhered to an edge that continues around the circumference of the second section. The lid may be peeled back to reveal the contents within the second section. In some embodiments, there may be a recess located in the second section to assist the user in lifting and peeling back the lid.

The lid may comprise a metal, paper, cardboard, wood or plastics material. Preferably, the lid is a metal foil.

The lid may comprise a tab to assist the user in peeling the lid. The tab may be an extension of the lid. When the housing is in the closed configuration, the tab may be located within a recess in the second section.

In some embodiments, the housing may comprise a peelable lid as a first section that is adhered to a second section comprising a cavity for receiving the gelatinous beverage, the housing being provided with a further cap that can cover the peelable lid. In such embodiments, the cap may clip over a rim projecting from the second section.

The beverage dispenser may be further provided with a tool for opening the first and second sections and/or the cap and the first and/or second section. The tool may comprise a key.

The tool may be attached to or separate to the beverage dispenser. Beneficially, the tool may also double-up as a means of assisting in the consumption of the gelatinous beverage contained within the housing.

The gelatinous beverage may be alcoholic or non-alcoholic.

Preferably, the beverage is alcoholic. For example, the beverage may comprise a predetermined volume of an alcoholic beverage.

The gelatinous beverage may comprise: at least one alcoholic ingredient, at least one gelling agent, at least one acidity regulator, at least one preservative and at least one dilutant.

The resulting gelatinous beverage is in a form suitable for direct consumption, has shown good stability for a prolonged period and maintains its structural integrity. Beneficially, it has been observed that the gel produced does not mix with other gels when brought into contact therewith.

The gelatinous beverage of the present invention has a texture, consistency and appearance similar to, or as near as possible to, that of an oyster and is thus is a gelatinous beverage with a unique mouth-feel. Having the alcoholic ingredient within a gel provides a delayed release of alcohol in the mouth of a user. Further, the gelatinous beverage provides a more pleasurable mouth feel than existing beverages. The gelatinous beverage has a melt-in-the-mouth feel, which enhances the enjoyment and pleasure for the user.

The gelatinous beverage may have a consistency that provides a low-friction contact with the housing. In such an embodiment, the gelatinous beverage may be dispensed from a beverage dispenser as described below simply by tilting the housing away from a horizontal plane.

The gelatinous beverage may comprise a suspension or dispersion of an alcoholic liquid beverage in a gelatinous material. The gelatinous beverage thus comprises a mixture of beverage and gelatinous material which results in a gel. The mixture may be homogenous.

The alcoholic ingredient is not limited in its nature and may comprise any ingredient containing alcohol, including pure alcohol (ethanol). For example, the alcoholic ingredient may be selected from ethanol or one or more ingredients comprising alcohol. Typically, alcoholic ingredients can be categorised under the following headings: beers, ciders, wines, spirits.

The alcoholic ingredient may also comprise a combination of different alcoholic and/or non-alcoholic drinks. The alcoholic ingredient may therefore comprise an alcoholic or non-alcoholic cocktail.

Preferably, the concentration of alcohol in the alcoholic ingredient is of a percentage of alcohol per volume (ABV) of at least 20%, more preferably 37.5% or above. The ABV of the alcoholic ingredient can be up to 40% or above.

Preferably, the ABV of the alcoholic ingredient is 37.5%.

Preferably, the at least one alcoholic ingredient comprises any of the following, either alone or in combination: vodka, whisky, rum, gin, tequila, absinthe, sambuca, brandy and other liquors or the like.

Preferably, the gelatinous beverage comprises around 35-60 wt % of the at least one alcoholic ingredient, more preferably around 40-50 wt % and most preferably around 46 wt %.

Typically, beers and ciders have an alcohol content of from around 0.1-9% ABV. Examples of beers and ciders suitable for use in the present invention include ale, larger, stout, bitter, dry cider, sweet cider and the like.

Typically, wines have an alcohol content of from around 9-16% ABV. The wine may be red wine, white wine or rose wine. Suitable wines also include fortified wines, such as sherry, port, Madeira and vermouth. Fortified wines may have an alcohol content of 16% ABV or above, typically in the range 16-22% ABV.

Typically, spirits have an alcohol content of at least 20% ABV. More typically, spirits have an alcohol content of at least 37.5% ABV.

The alcohol content of the gelatinous beverage may be up to around 25% ABV, preferably up to around 20% ABV and most preferably around 17% ABV. Good results have been observed in a gelatinous beverage with an alcohol content of 17.25% ABV.

The at least one gelling agent may comprise any gelling agent suitable for human consumption. Typical gelling agents include natural gums, starches, pectins, agar-agar and gelatine. The at least one gelling agent may comprise a polysaccharide.

Preferably, the at least one gelling agent comprises any of the following, either alone or in combination: gelatine, xanthan gum (e.g. Keltrol® T), locust bean gum, gellan gum (e.g. Kelcogel® F) or derivatives thereof. Preferably, the gelling agent comprises a vegetarian based gelling agent. Beneficially, where the gelling agent is a vegetarian based, the gelatinous beverage has a longer shelf-life.

The gelling agent may comprise a mixture of more than one gelling agents. Preferably, the at least one gelling agent comprises a mixture of locust bean gum, xanthan gum and gellan gum.

The gelatinous beverage may comprise less than 1 wt %, preferably less than 0.5 wt % and more preferably less than 0.2 wt % of the gelling agent or gelling agents. Beneficially, the gelatinous beverages having a total gelling agent content of less than 0.2 wt % provides the desirable consistency and mouth-feel and gives the gelatinous beverage a clean taste and good clarity. Good results have been observed wherein the gelatinous beverage comprises 0.19 wt % of one or more gelling agents.

The term ‘acidity regulator’ is used herein to refer to a food additive capable of changing or maintaining the pH of the gelatinous beverage. Preferably, the pH of the gelatinous beverage is around pH4.

The at least one acidity regulator may comprise any acidity regulator suitable for human consumption. Typical acidity regulators may include adipic acid, sodium adipate, potassium adipate, ammonium adipate, succinic acid, sodium fumarate, potassium fumarate, calcium fumarate, ammonium fumarate, 1,4-Heptonolactone, triammonium citrate, ammonium ferric citrate, calcium glycerylphosphate, isopropyl citrate, sodium tartrates, potassium tartrates, sodium potassium tartrate, sodium lactate, potassium lactate, calcium lactate, ammonium lactate, magnesium lactate, citric acid, sodium citrates, potassium citrates, calcium citrates, malic acid, fumaric acid, sodium acetates and calcium acetate.

The at least one acidity regulator may comprise a mixture of more than one acidity regulator. Preferably, the at least one acidity regulator comprises a mixture of sodium citrate, citric acid and malic acid.

Preferably, the gelatinous beverage comprises up to around 1 wt % of the at least one acidity regulator, more preferably up to around 0.5 wt % and most preferably up to around 0.45 wt %.

The term ‘preservative’ is used herein to refer to a food additive capable of preventing decomposition of the beverage by microbial growth or by undesirable chemical changes.

The at least one preservative may comprise any preservative suitable for human consumption. Typical preservatives include sorbic acid, sodium sorbate, potassium sorbate, calcium sorbate, heptyl p-hydroxybenzoate, benzoic acid, sodium benzoate, potassium benzoate, calcium benzoate, ethylparaben, sodium ethyl para-hydroxybenzoate, propylparaben, odium propyl para-hydroxybenzoate, methylparaben, sodium methyl para-hydroxybenzoate, sulphur dioxide, sodium sulphite, sodium bisulphite, sodium metabisulphite, potassium metabisulphite, potassium sulphite, calcium sulphite, potassium hydrogen sulphite, biphenyl, diphenyl, orthophenyl phenol, sodium orthophenyl phenol, thiabendazole, nisin, natamycin, pimaracin, formic acid, sodium formate, calcium formate, hexamine, formaldehyde, dimethyl dicarbonate, potassium nitrite, sodium nitrite, sodium nitrate, potassium nitrate, ammonium acetate, dehydroacetic acid, sodium dehydroacetate, propionic acid, sodium propionate, calcium propionate, potassium propionate, boric acid, sodium tetraborate (borax).

Preferably, the at least one preservative is selected from the group consisting of sorbic acid, sodium sorbate, potassium sorbate, calcium sorbate, and mixtures thereof. More preferably, the at least one preservative comprises potassium sorbate.

The at least one preservative may comprise more than one preservative.

Preferably, the gelatinous beverage comprises up to around 1 wt % of the at least one preservative, more preferably up to around 0.5 wt % and most preferably around 0.1 wt %.

The gelatinous beverage of the present invention has been shown to be stable for a period of greater than three months.

The at least one dilutant may comprise any dilutant suitable for human consumption. Preferably, the at least one dilutant comprises water.

The gelatinous beverage may comprise up to around 60 wt % of the at least one dilutant, more preferably up to around 55 wt % and most preferably around 52 wt %. Good results have been observed wherein the gelatinous beverage comprises from around 45 to 55 wt % of at least one dilutant, preferably from around 50 to 52 wt %.

The gelatinous beverage may comprise additional ingredients including energising ingredient, sweetening agents, flavouring agents, aphrodisiacs, colouring agents, drink mixers or combinations thereof, as desired or as appropriate. The additional ingredients may be suspended or dissolved in the gelatinous beverage.

In some embodiments, the gelatinous beverage comprises an aphrodisiac. In other embodiments, the gelatinous beverage comprises an energising ingredient. In some embodiments, the gelatinous beverage comprises a combination of an aphrodisiac and an energising ingredient.

Suitable energising ingredients may comprise any energising ingredient suitable for human consumption. Suitable energising ingredients can include caffeine, taurine, Cramer®. Preferably, the energising ingredient comprises Cramer®.

Preferably, the gelatinous beverage comprises up to around 1 wt % of at least one energising ingredient, more preferably up to around 0.5 wt %, even more preferably around 0.1 wt % and most preferably up to 0.05 wt %. Good results have been observed with 0.04 wt % energising ingredient.

Suitable aphrodisiacs may comprise any aphrodisiac ingredient suitable for human consumption. Suitable aphrodisiacs can include ginseng extract and damiana.

Preferably, the gelatinous beverage comprises up to around 1 wt % of at least one aphrodisiac, more preferably up to around 0.5 wt %, and most preferably up to around 0.1 wt %. Good results have been observed with 0.1 wt % aphrodisiac.

Suitable sweetening agents may include sugars such as sucrose, lactose, fructose, glucose, or sugar substitutes such as sorbitol, xylitol, stevia, aspartame, sucralose, neotame, acesulfame potassium, saccharin and combinations thereof. Many other sweetening agents are suitable for use in the present invention and such sweetening agents would be within the knowledge of a skilled person.

Preferably, the sweetening agent comprises sucralose.

Suitable flavouring agents include flavourings such as fruit flavours, mint flavours, sour or bitter flavours, or combinations thereof. Preferred fruit flavours include lemon, lime, orange, apple, tomato and cranberry flavours. For example, the gelatinous beverage may comprise a mixture of vodka as the alcoholic ingredient and lime flavouring, or a mixture of gin as the alcoholic ingredient and lemon flavouring. Many other flavouring agents are suitable for use in the present invention and such flavouring agents would be within the knowledge of a skilled person.

A suitable colouring agent may include caramel. Colouring agents may be incorporated as desired to change the appearance of the gelatinous beverage. Suitable colouring agents will be known to a person skilled in the art. For example, where the gelatinous beverage is to comprise a gin alcoholic ingredient and lemon flavouring, a green colorant may be added to the beverage. Alternatively, where the gelatinous beverage is to comprise a vodka and lime, a blue colouring may be added to the beverage.

The term “drink mixer” is used herein to mean a non-alcoholic ingredient added to the gelatinous beverage to change the characteristic of the beverage, such as for example, its flavour, taste, alcohol content and/or consistency. Typical drink mixers will be known to a person skilled in the art and may comprise carbonated beverages such as soda water, cola, ginger ale, lemonade and tonic water; and dairy beverages such as cream or milk.

The gelatinous beverage may be any shape suitable to be contained within the housing and may, for example, be a spherical, spheroidal, disc or cylindrical shape. When the shape is cylindrical, the ends of the cylinder may be capped with hemi-spheres. Preferably, the gel resembles the shape of a natural oyster.

According to a second aspect of the present invention, there is provided a gelatinous beverage as described herein.

According to a third aspect of the present invention, there is provided a method for delivering a gelatinous beverage as described herein to a user, the method comprising the steps of: moving a housing as described herein from a closed configuration in which the gelatinous beverage is sealed within the housing to an open configuration in which the gelatinous beverage can be dispensed from the housing and consuming the gelatinous beverage contained within the housing.

According to a fifth aspect of the present invention, there is provided a method of manufacturing a beverage dispenser as described herein, the method comprising the steps of (i) preparing a housing as described herein; (ii) preparing a gelatinous beverage as described herein; (iii) inserting the gelatinous beverage into the housing; and (iv) sealing the housing in a closed configuration.

The sealing may comprise the step of vacuum packing the gelatinous beverage within the housing. The vacuum packing can be conducted by any means known in the art. Beneficially, this provides the beverage dispenser with an increased shelf-life.

Step (i) may comprise preparing a plastics housing as described herein by extrusion or blow moulding. In some embodiments, the housing may comprise a foil lid and a plastics section suitable for receiving the gelatinous beverage. In such an embodiment, the sealing may comprise adhering the lid to the plastics section, so that in use it can be peeled back by a user.

The gelatinous beverage contained within the housing may have a volume of from around 1-50 ml. Typically, the gelatinous beverage may have a volume of from around 5-35 ml. Preferably, the gelatinous beverage has a volume of around 25 ml.

According to a further aspect of the present invention, there is provided a method for making a gelatinous beverage as described herein comprising the steps of:
(a) heating a dilutant;
(b) adding at least one acidity regulator, at least one preservative, and at least one gelling agent to the dilutant and mixing to faun a mixture;
(c) cooling the mixture; and
(d) adding at least one alcoholic ingredient.

The mixture obtained following step (d) may be in liquid form. In such an embodiment, the liquid mixture may be decanted into a mould, such as for example, a housing as described herein. The gelatinous beverage mixture may then cool and set to form a gelatinous beverage as described herein.

The step of mixing the gelling agent with the dilutant and alcoholic ingredient results in the gelling agent being dispersed within the mixture. This mixture may be a homogenous solution. Alternatively, the mixture may form a suspension.

In some embodiments, the at least one gelling agent, at least one acidity regulator and at least one preservative may be dry blended before being added to the water in step (b).

In some embodiments, the at least one gelling agent, at least one acidity regulator and at least one preservative may be dry blended and added to the water in step (b) followed by high-shear mixing.

The water may be heated in step (a) to around 80-90° C., more preferably around 85° C.

In some embodiments, the at least one gelling agent, at least one acidity regulator and at least one preservative may be added to the water having a temperature of around 70° C. in step (b), the mixture then being further heated to around 85° C.

The mixture may be cooled in step (c) once the temperature of the mixture reaches a temperature of around 85° C.

In some embodiments, the at least one alcoholic ingredient is added when the mixture has cooled to around 40° C.

Preferably, the alcoholic ingredient is added to the mixture in step (d) after having been incubated overnight, or for at least six hours.

The method of the present invention may further comprise a step (e) comprising adding additional ingredients including energising components, sweetening agents, flavouring agents, aphrodisiacs, colouring agents or combinations thereof.

It will be appreciated that the features described in relation to the above aspects of the invention apply to the other aspects of the invention where appropriate.

Embodiments of the present invention will now be described further in the following non-limiting examples with reference to the accompanying drawings in which:

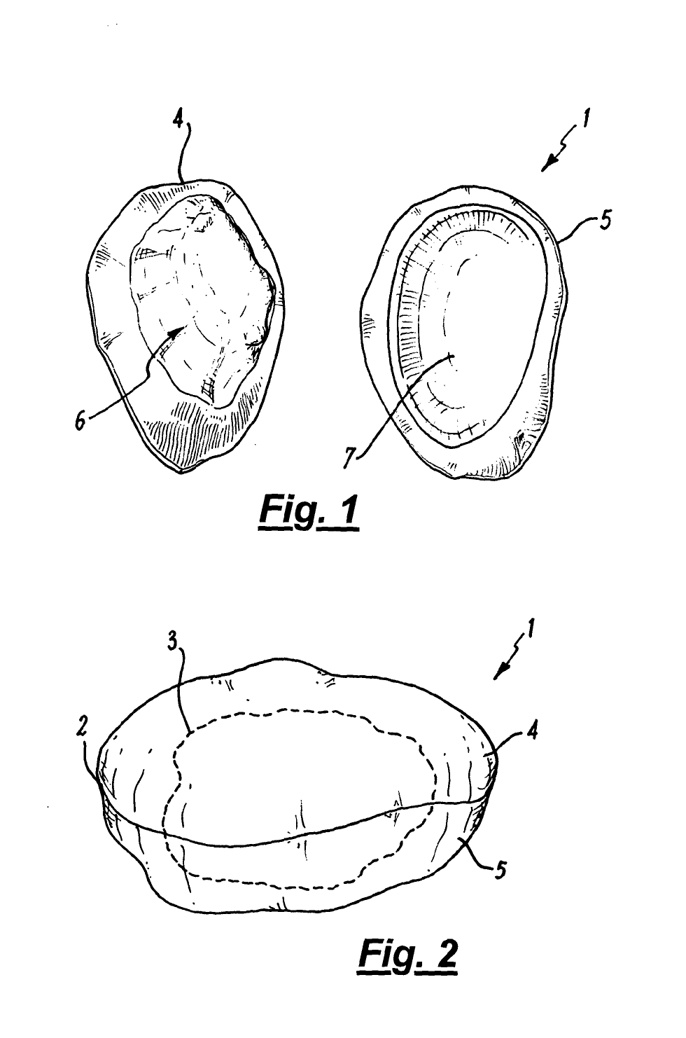

FIG. 1: a representation of a beverage dispenser of the present invention in an open position;

FIG. 2: a representation of a beverage dispenser of the present invention in a closed position;

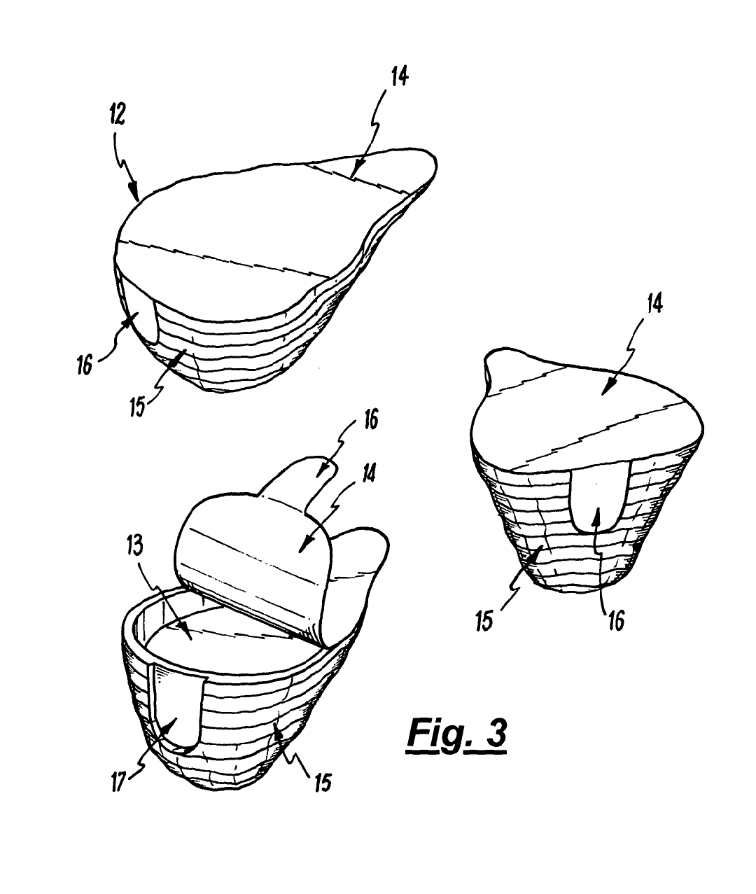

FIG. 3: a representation of an alternative beverage dispenser of the present invention;

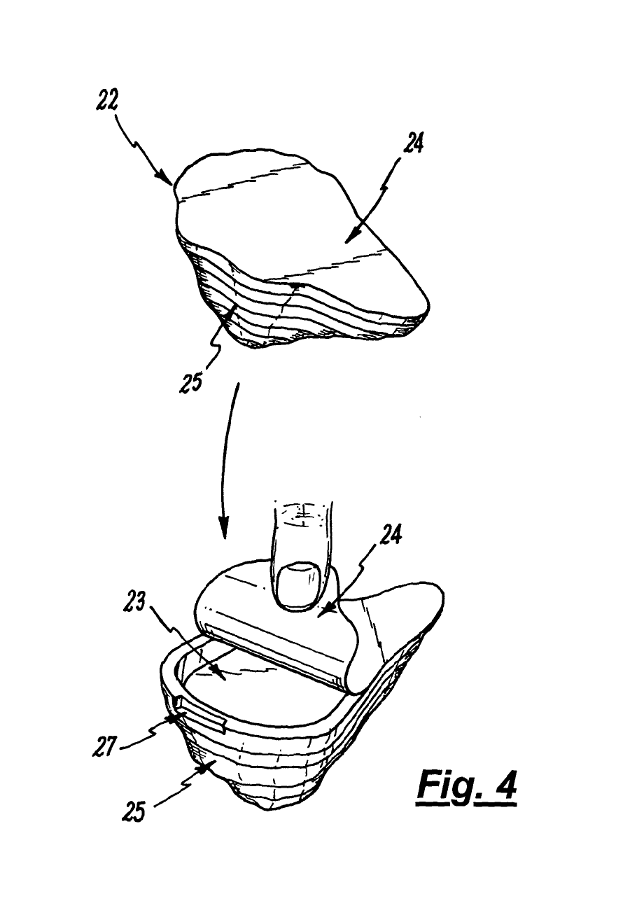

FIG. 4: a representation of a further alternative beverage dispenser of the present invention;

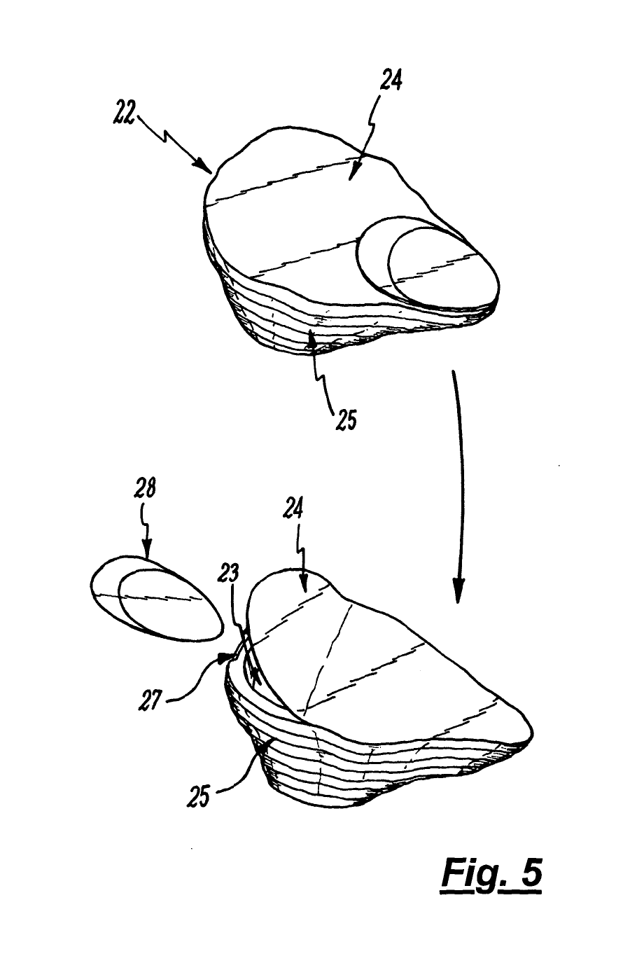

FIG. 5: a representation of a beverage dispenser with a tool to assist opening;

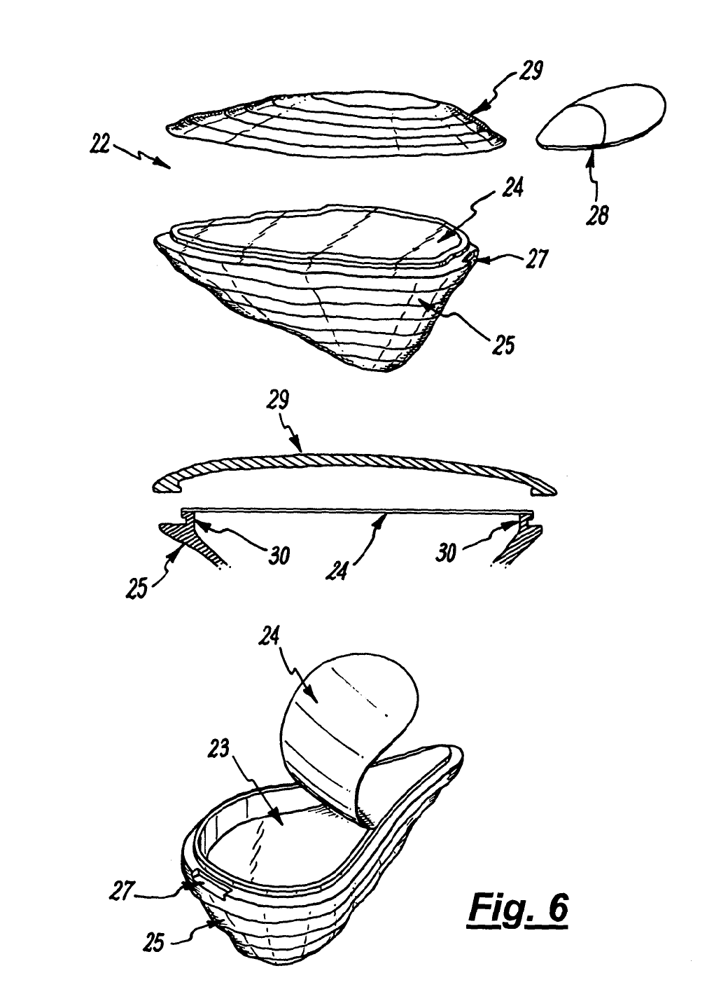

FIG. 6: a representation of a beverage dispenser with a cap.

Reference is made herein to the beverage dispenser of the present invention being used to provide a means of dispensing a gelatinous beverage as exemplified in Examples 1 to 6 to a user. It will of course be understood that reference to such a gelatinous beverage is for example purposes only and the invention is not limited to such embodiments.

Referring to FIGS. 1 and 2, there is shown a beverage dispenser 1 comprising a housing 2 and a gelatinous beverage 3 (not shown in FIG. 1).

The housing 2 is in the shape of an oyster shell. The housing comprises a first section 4 and a second section 5. The first and second sections 4,5 comprise respective recesses 6,7. If it is desired to open the housing 2, a user can apply opposing pressure to the first and second sections 4,5 to separate the first and second sections 4,5 and thus move the housing 2 into an open configuration. In the open configuration, the user has access to the gelatinous beverage 3 contained within the housing 2. The first and second sections 4,5 may be connected by adhesive. Alternatively, the first and second sections 4,5 may be in pivotal connection about a pivot or comprise a peg and hole fastening arrangement whereby pegs are arranged to fit into corresponding holes, respectively.

The gelatinous beverage 3 may comprise a composition as described herein and exemplified in Examples 1 to 6 below.

In use, the user opens the housing 2 by moving the housing from a closed configuration in which the gelatinous beverage 3 is contained within the housing to an open configuration in which the gelatinous beverage 3 can be dispensed from the housing 2 as described hereinbefore. The user may then raise the housing 2 to his/her mouth and consume the gelatinous beverage 3. The gelatinous beverage 3 has a pleasurable melt-in-the-mouth feel. As such, upon dispensing of the gelatinous beverage 3 into the mouth, the user experiences a more pleasurable and enjoyable feeling than when consuming known beverages from known dispensers.

Referring to FIG. 3, there is shown an alternative example of a beverage dispenser of the present invention. The housing 12 comprises a lid first section 14 and a receptacle second section 15 suitable for receiving a gelatinous beverage 13. The receptacle 15 comprises a central cavity for receiving the gelatinous beverage 13.

The lid 14 is adhered to the receptacle 15 and comprises a tab 16. When the housing 12 is in the closed configuration, the tab 16 is located within a recess 17.

Similarly to that described above, in use the user opens the housing 12 by moving the housing from a closed configuration in which the gelatinous beverage 13 is contained within the housing 12 to an open configuration in which the gelatinous beverage 13 can be dispensed from the housing 12 by peeling back the lid 14 using the tab 16. The user may then raise the housing 12 to his/her mouth and consume the gelatinous beverage 13.

Referring to FIG. 4, there is shown a beverage dispenser comprising a housing 22, the housing 22 comprising a lid first section 24 and a receptacle second section 25 suitable for receiving a gelatinous beverage 23. The receptacle 25 comprises a central cavity for receiving the gelatinous beverage 23. The lid 24 is adhered to the circumferential edge of the receptacle 25. The receptacle 25 comprises a recess 27 to assist the user in peeling back the lid 24 to reveal the gelatinous beverage 23.

Referring to FIG. 5, there is shown a beverage dispenser as in FIG. 4 with a disc 28 attached to the lid 24. The disc 28 can be detached from the lid 24 and serves as a tool to assist in separating the lid 24 from the receptacle 25.

Referring to FIG. 6, there is shown a beverage dispenser comprising a housing 22, the housing 22 comprising a lid first section 24 and a receptacle second section 25 suitable for receiving a gelatinous beverage 23. The receptacle 25 comprises a central cavity for receiving the gelatinous beverage 23. The lid 24 is adhered to the circumferential edge of the receptacle 25. The receptacle 25 comprises a recess 27 to assist the user in peeling back the lid 24 to reveal the gelatinous beverage 23. The beverage dispenser further comprises a cap 29 that can clip over a rim 30 projecting from the receptacle 25. The beverage dispenser can further be provided with a disc 28 for assisting in separating the cap 29 and lid 24 from the receptacle 25.

### Preparation of Gelatinous Beverage

### Process 1:

The following exemplary method has been used in the production of a gelatinous beverage of the present invention:
(1) Clean and sanitise work area and equipment;
(2) Heat water whilst being mixed by a Silverson mixer at a speed of 1000 rpm;
(3) Measure out and dry blend at least one acidity regulator, at least one gelling agent, and at least one preservative;
(4) Add the dry blend to the water once it reaches a temperature of 70° C.;
(5) Mix with the Silverson mixer at a speed of 8000 rpm;
(6) Continue heating and mixing until the mixture reaches 85° C.;
(7) Cool the mixture to 65° C. whilst maintaining mixing and hold at this temperature for two minutes;
(8) Continue cooling the mixture to 40° C.;
(9) Add at least one alcoholic ingredient to the mixture, together with any additional ingredient;
(10) Stop mixing and decant the mixture into the desired beverage dispenser;
(11) Allow the mixture to cool and set; and
(12) Seal the beverage dispenser into a closed configuration.

### EXAMPLE 1

A gelatinous beverage having the following composition was prepared according to Process 1:

| Ingredients | wt % | Serving size (g) | Batch size (g) |
|---|---|---|---|
| Tap water | 53.325 | 13.331 | 159.975 |
| Vodka (37.5% ABV) | 46.000 | 11.500 | 138.000 |
| Kelcogel F ® | 0.025 | 0.006 | 0.075 |
| Keltrol T ® | 0.050 | 0.013 | 0.150 |
| Locust bean gum | 0.050 | 0.013 | 0.150 |
| Sodium citrate | 0.150 | 0.038 | 0.450 |
| Citric acid | 0.150 | 0.038 | 0.450 |
| Malic acid | 0.150 | 0.038 | 0.450 |
| Potassium sorbate | 0.100 | 0.025 | 0.300 |
| | 100.000 | 25.000 | 300.000 |

### EXAMPLE 2

A gelatinous beverage having the following composition was prepared according to Process 1:

| Ingredients | wt % | Serving size (g) | Batch size (g) |
|---|---|---|---|
| Tap water | 53.260 | 13.315 | 159.780 |
| Vodka (37.5% ABV) | 46.000 | 11.500 | 138.000 |
| Kelcogel F ® | 0.040 | 0.010 | 0.120 |
| Keltrol T ® | 0.075 | 0.019 | 0.225 |
| Locust bean gum | 0.075 | 0.019 | 0.225 |
| Sodium citrate | 0.150 | 0.038 | 0.450 |
| Citric acid | 0.150 | 0.038 | 0.450 |
| Malic acid | 0.150 | 0.038 | 0.450 |
| Potassium sorbate | 0.100 | 0.025 | 0.300 |
| | 100.000 | 25.000 | 300.000 |

The gelatinous beverage provided a clean taste with good clarity. A 25 g serving of the gelatinous beverage delivered approximately half a unit of alcohol and had an alcohol content of 17.25% and a pH of approximately 4.07. The gelatinous beverage showed a stability of greater than three months.

### EXAMPLE 3

A gelatinous beverage having the following composition, including an energising ingredient and an aphrodisiac was prepared according to Process 1:

| Ingredients | wt % | Serving size (g) | Batch size (g) |
|---|---|---|---|
| Tap water | 52.513 | 13.1283 | 157.539 |
| Vodka (37.5% ABV) | 46.0 | 11.5000 | 138.000 |
| Taurine | 0.400 | 0.1000 | 1.200 |
| Sodium citrate | 0.150 | 0.0375 | 0.450 |
| Citric acid | 0.150 | 0.0375 | 0.450 |
| Malic acid | 0.150 | 0.0375 | 0.450 |
| Potassium sorbate | 0.100 | 0.0250 | 0.300 |
| Damiana extract | 0.100 | 0.0250 | 0.300 |
| Panax Ginseng Extract | 0.100 | 0.0250 | 0.300 |
| Keltrol T ® | 0.075 | 0.0188 | 0.225 |
| Locust bean gum | 0.075 | 0.0188 | 0.225 |
| Caramel | 0.075 | 0.0188 | 0.225 |
| Kelcogel F ® | 0.040 | 0.0100 | 0.120 |
| Cramer (energy | 0.040 | 0.0100 | 0.120 |
| flavouring) | | | |
| Caffeine | 0.030 | 0.0075 | 0.090 |
| Sucralose | 0.002 | 0.0005 | 0.006 |
| | 100.000 | 25.0000 | 300.000 |

### EXAMPLE 4

A gelatinous beverage having the following composition, including an energising ingredient and an aphrodisiac was prepared according to Process 1:

| Ingredients | wt % | Serving size (g) | Batch size (g) |
|---|---|---|---|
| Tap water | 53.045 | 13.261 | 159.135 |
| Vodka (37.5% ABV) | 46.000 | 11.500 | 138.000 |
| Sodium citrate | 0.150 | 0.038 | 0.450 |
| Citric acid | 0.150 | 0.038 | 0.450 |
| Malic acid | 0.150 | 0.038 | 0.450 |
| Potassium sorbate | 0.100 | 0.025 | 0.300 |
| Panax Ginseng Extract | 0.100 | 0.025 | 0.300 |
| Keltrol T ® | 0.075 | 0.019 | 0.225 |
| Locust bean gum | 0.075 | 0.019 | 0.225 |
| Caramel | 0.075 | 0.019 | 0.225 |
| Kelcogel F ® | 0.040 | 0.010 | 0.120 |
| Cramer (energy | 0.040 | 0.010 | 0.120 |
| flavouring) | | | |
| | 100.000 | 25.000 | 300.000 |

### EXAMPLE 5

A gelatinous beverage having the following composition, including an energising ingredient and an aphrodisiac was prepared according to Process 1:

| Ingredients | wt % | Serving size (g) | Batch size (g) |
|---|---|---|---|
| Tap water | 53.045 | 13.261 | 159.135 |
| Vodka (37.5% ABV) | 46.000 | 11.500 | 138.000 |
| Sodium citrate | 0.150 | 0.038 | 0.450 |
| Citric acid | 0.150 | 0.038 | 0.450 |
| Malic acid | 0.150 | 0.038 | 0.450 |
| Potassium sorbate | 0.100 | 0.025 | 0.300 |
| Damiana extract | 0.100 | 0.025 | 0.300 |
| Keltrol T ® | 0.075 | 0.019 | 0.225 |
| Locust bean gum | 0.075 | 0.019 | 0.225 |
| Caramel | 0.075 | 0.019 | 0.225 |
| Kelcogel F ® | 0.040 | 0.010 | 0.120 |
| Cramer (energy | 0.040 | 0.010 | 0.120 |
| flavouring) | | | |
| | 100.000 | 25.000 | 300.000 |

### EXAMPLE 6

A gelatinous beverage having the following composition, including an energising ingredient and an aphrodisiac was prepared according to Process 1:

| Ingredients | wt % | Serving size (g) | Batch size (g) |
|---|---|---|---|
| Tap water | 52.715 | 13.179 | 158.145 |
| Vodka (37.5% ABV) | 46.000 | 11.500 | 138.000 |
| Taurine | 0.400 | 0.100 | 1.200 |
| Sodium citrate | 0.150 | 0.038 | 0.450 |
| Citric acid | 0.150 | 0.038 | 0.450 |
| Malic acid | 0.150 | 0.038 | 0.450 |
| Potassium sorbate | 0.100 | 0.025 | 0.300 |
| Keltrol T ® | 0.075 | 0.019 | 0.225 |
| Locust bean gum | 0.075 | 0.019 | 0.225 |
| Caramel | 0.075 | 0.019 | 0.225 |
| Kelcogel F ® | 0.040 | 0.010 | 0.120 |
| Cramer (energy | 0.040 | 0.010 | 0.120 |
| flavouring) | | | |
| Caffeine | 0.030 | 0.008 | 0.090 |
| | 100.000 | 25.000 | 300.000 |

It is of course to be understood that the present invention is not intended to be restricted to the foregoing examples which are described by way of example only. Although a few examples have been shown and described, it will be appreciated by those skilled in the art that various changes and modifications might be made without departing from the scope of the invention.

1. A beverage dispenser comprising a housing and a gelatinous beverage contained within the housing, the housing being configured for movement between a closed configuration in which the gelatinous beverage is sealed within the housing and an open configuration in which the gelatinous beverage may be dispensed from the housing.

2-5. (canceled)

6. A beverage dispenser as claimed in claim 1, wherein the housing comprises first and second sections, wherein the housing is substantially in the shape of an oyster shell, whereby the first and second sections correspond to the two half-shells of the oyster shell.

7-13. (canceled)

14. A beverage dispenser as claimed in claim 6, wherein the first section comprises a lid and the second section is suitable for receiving the gelatinous beverage, wherein the lid is adhered to an edge that is continuous around the circumference of the second section.

15. A beverage dispenser as claimed in claim 6, wherein the dispenser is further provided with a tool for opening the first and second sections.

16. A beverage dispenser as claimed in claim 1, wherein the gelatinous beverage contained therein is alcoholic, wherein the gelatinous beverage optionally comprises at least one alcoholic ingredient, at least one gelling agent, at least one acidity regulator, at least one preservative and at least one dilutant.

17-22. (canceled)

23. A beverage dispenser as claimed in claim 16, wherein the gelatinous beverage comprises from 35 to 60 wt % of the at least one alcoholic ingredient.

24-25. (canceled)

26. A beverage dispenser as claimed in claim 16, wherein the at least one gelling agent is selected from one or more of the group consisting of: natural gums, starches, pectins, agar-agar and gelatine; and/or wherein the gelatinous beverage comprises less than 0.2 wt % of the at least one gelling agent.

27-29. (canceled)

30. A beverage dispenser as claimed in claim 16, wherein the acidity regulator is selected from one or more of the group consisting of: adipic acid, sodium adipate, potassium adipate, ammonium adipate, succinic acid, sodium fumarate, potassium fumarate, calcium fumarate, ammonium fumarate, 1,4-Heptonolactone, triammonium citrate, ammonium ferric citrate, calcium glycerylphosphate, isopropyl citrate, sodium tartrates, potassium tartrates, sodium potassium tartrate, sodium lactate, potassium lactate, calcium lactate, ammonium lactate, magnesium lactate, citric acid, sodium citrates, potassium citrates, calcium citrates, malic acid, fumaric acid, sodium acetates and calcium acetate; and/or wherein the gelatinous beverage comprises up to around 1 wt % of the at least one acidity regulator.

31-34. (canceled)

35. A beverage dispenser as claimed in claim 16, wherein the preservative is selected from one or more of the group consisting of: sorbic acid, sodium sorbate, potassium sorbate, calcium sorbate, heptyl p-hydroxybenzoate, benzoic acid, sodium benzoate, potassium benzoate, calcium benzoate, ethylparaben, sodium ethyl para-hydroxybenzoate, propylparaben, odium propyl para-hydroxybenzoate, methylparaben, sodium methyl para-hydroxybenzoate, sulphur dioxide, sodium sulphite, sodium bisulphite, sodium metabisulphite, potassium metabisulphite, potassium sulphite, calcium sulphite, potassium hydrogen sulphite, biphenyl, diphenyl, orthophenyl phenol, sodium orthophenyl phenol, thiabendazole, nisin, natamycin, pimaracin, formic acid, sodium formate, calcium formate, hexamine, formaldehyde, dimethyl dicarbonate, potassium nitrite, sodium nitrite, sodium nitrate, potassium nitrate, ammonium acetate, dehydroacetic acid, sodium dehydroacetate, propionic acid, sodium propionate, calcium propionate, potassium propionate, boric acid, sodium tetraborate (borax); and/or wherein the gelatinous beverage comprises up to around 1 wt % of the at least one preservative.

36-40. (canceled)

41. A beverage dispenser as claimed in claim 16, wherein the at least one dilutant comprises water; and/or wherein the gelatinous beverage comprises up to around 60 wt % of the at least one dilutant.

42-44. (canceled)

45. A beverage dispenser as claimed in claim 1, wherein the gelatinous beverage comprises one or more additional ingredients selected from the group consisting of: energising ingredient, sweetening agents, flavouring agents, aphrodisiacs, colouring agents, drink mixers or combinations thereof.

46. A beverage dispenser as claimed in claim 45, wherein the gelatinous beverage comprises a combination of an aphrodisiac and an energising ingredient.

47. (canceled)

48. A beverage dispenser as claimed in claim 45, wherein the gelatinous beverage comprises up to around 1 wt % of at least one energising ingredient; and/or wherein the gelatinous beverage comprises up to around 1 wt % of at least one aphrodisiac.

49-50. (canceled)

51. A beverage dispenser as claimed in claim 45, wherein the sweetening agent is selected from one or more of the group consisting of: sucrose, lactose, fructose, glucose, or sugar substitutes such as sorbitol, xylitol, stevia, aspartame, sucralose, neotame, acesulfame potassium, saccharin and combinations thereof.

52. A beverage dispenser as claimed in claim 45, wherein the flavouring agent is selected from fruit flavours, mint flavours, sour or bitter flavours, or combinations thereof.

53-54. (canceled)

55. A beverage dispenser as claimed in claim 1, wherein the gelatinous beverage has a volume of from 1 to 50 ml.

56-57. (canceled)

58. A gelatinous beverage comprising at least one alcoholic ingredient, at least one gelling agent, at least one acidity regulator, at least one preservative and at least one dilutant.

59. (canceled)

60. A method of manufacturing the beverage dispenser of claim 1, the method comprising the steps of (i) preparing a housing; (ii) preparing a gelatinous beverage of claim 58; (iii) inserting the gelatinous beverage into the housing; and (iv) sealing the housing in a closed configuration.

61-63. (canceled)

62. A method for making a gelatinous beverage of claim 58 comprising the steps of:
heating a dilutant;
adding at least one acidity regulator, at least one preservative, and at least one gelling agent to the dilutant and mixing to form a mixture;
cooling the mixture; and
adding at least one alcoholic ingredient.

65-70. (canceled)

71. A method as claimed in claim 64, further comprising a step (e) comprising adding additional ingredients including energising components, sweetening agents, flavouring agents, aphrodisiacs, colouring agent or combinations thereof.

72. (canceled)
